(19) United States
(12) Patent Application Publication
(10) Pub. No.: US 2005/0112370 A1
(43) Pub. Date: May 26, 2005

(54) Fake-proof adhesive tape

(75) Inventor: Chung-Chin Wang, Taoyuan (TW)

Correspondence Address: SHOEMAKER AND MATTARE, LTD, 10 POST OFFICE ROAD - SUITE 110, SILVER SPRING, MD, 20910, US

(73) Assignee: Seal King Industrial Co., Ltd., Taoyuan (TW)

(21) Appl. No.: 10/938,949

(22) Filed: Sep. 13, 2004

(30) Foreign Application Priority Data
Nov. 20, 2003 (TW) 092220517

(51) Int. Cl. B32B 7/12

(52) U.S. Cl. 428/354

(57) ABSTRACT

A fake-proof adhesive tape having a substrate, a first identification layer, a second identification layer, a first adhesive layer, a second adhesive layer, and at least a reinforced portion is proposed. The reinforced portion is locally formed at least between the substrate and the first adhesive layer to strengthen an adhesion between the first adhesive layer and the second adhesive layer, thereby preventing peeling between the first identification layer and the second identification layer when the fake-proof adhesive tape is used.

### BACKGROUND OF THE INVENTION

1. Field of the Invention

The present invention relates to a fake-proof adhesive tape, more particularly, to a fake-proof adhesive tape for revealing a sealing state of an article.

2. Description of Prior Art

With the development of high technology and growing demand for security by consumers, fake-proof paper, fake-proof film, and fake-proof adhesive tape having fake-proof characteristics, are applicable to important document envelops, express delivery envelops, cash bags, court evidence bags, electronic item, or seals for controlled drugs, and to provide a seal for identification documents?packages, boxes, drawers, safety box, towed cars and so on. For a conventional fake-proof adhesive tape, a coating layer having fake-proof sign can be coated on a back surface of the substrate of the adhesive tape, and glue adhesive can be coated on the coating layer, such that an article can be sealed with the fake-proof adhesive tape.

Since the coating layer is made of a material different from other coating materials, and an adhesion between the coating layer and the adhesive layer is stronger than an adhesion between the coating layer and the substrate, the fake-proof mark on the coating layer is left on the sealed article for showing integrity at the sealing state, after the fake-proof adhesive tape is torn from the substrate. However, if the seal is broken to lose integrity after the conventional fake-proof adhesive tape is torn from the substrate, the article can no longer be kept at the sealed state with security.

To solve the drawbacks associated with the conventional fake-proof adhesive tape, another Taiwan application regarding to a fake-proof adhesive tape was filed on Oct. 11?1999 and published on May 1, 2001 with a publication No. 433279. A mark layer with adhesive material is printed on the back surface of the fake-proof adhesive tape, while a colored layer is coated on the mark layer and portions of the substrate free of the mark layer. An adhesive layer and a glue adhesive layer are formed in sequence on the colored layer, allowing the fake-proof adhesive tape to adhere to the article to be sealed.

An adhesion between the mark layer and the colored layer is weaker than an adhesion between the adhesive film layer and the colored layer, and the adhesion between the mark layer and the colored layer is also weaker than an adhesion between the substrate and the mark layer. On the contrary, an adhesion between the substrate and the colored layer is stronger than the adhesion between the viscous layer and the colored layer. As a result, the conventional fake-proof adhesive tape can clearly reveal the sealing state?and the seal end can still be kept tightly sealed even though the substrate is torn, providing double protections for the article to be sealed.

However, if the adhesion between the mark layer and the colored layer is too strong, the mark layer and the color layer can be viewed as tightly connected into a body film with no separation. Thus, the identifiable mark is not revealed after the substrate is torn. On the other hand, if the adhesion between the mark layer and the colored layer is weak, the mark layer and the colored layer are not tightly connected. However, the adhesion between the mark layer and the colored layer may not be tight enough when the fake-proof adhesive tape is torn for adhering to the article to be sealed, resulting a peeling effect that resembles a damaged seal between the mark layer and the colored layer as the conventional fake-proof adhesive tape is torn, as shown in FIG. 16.

Accordingly, the adhesion between the mark layer and the colored layer is not controlled with ease, causing drawbacks, such as difficulty in separating the mark layer from the colored layer and peeling, if a user wishes to tears the fake-proof adhesive tape for adhering to the article to be sealed. Thus, it is inconvenient for the user to utilize the adhesive tape. And since the identification function is further affected by the peeling effect, further improvements are needed.

Since, the fake-proof adhesive tape with characteristics of fake-proof and security is not provided by the conventional techniques, more improvements are required to resolve prior art problems related to keeping the tight seal, fake-proof identification, and utilizing.

### SUMMARY OF THE INVENTION

In light of the drawbacks associated with the conventional technologies as described above, one objective of the present invention is to provide a fake-proof adhesive tape that ensures fake-proof sealing.

It is another objective of the present invention to provide a fake-proof adhesive tape that can be torn easily.

In accordance with the foregoing and other objectives, the invention provides a fake-proof adhesive tape, which has a substrate, a first identification layer, a second identification layer, a first adhesive layer, a second adhesive layer, and at least a reinforced portion.

The first identification layer is locally formed on a surface of the substrate and is made of the same material for making the substrate. Also, the first identification layer is formed with tearing marks that reveal identification state by using any of the known printed techniques, so as to show the sealing state of the fake-proof adhesive tape via the marks. The second identification layer is formed over the surface of the substrate on which the first identification layer is formed to completely cover the first identification layer, and can select any material having color that contrast with that of the substrate and the first identification layer, so that the damaged seal be can clearly identified after the substrate is torn off.

The first adhesive layer is formed on a surface of the second identification layer away from the first identification layer, so the second identification layer formed on the first identification layer is kept thereon and adheres to the article to be sealed via the first adhesive layer while maintaining sealing end tightly sealed, after the substrate is torn from the fake-proof adhesive tape. Preferably, the color of the first adhesive layer contrasts to that of the second adhesive layer. Thus, the user can check whether the sealed state has been damaged or not after the substrate is torn from the sealed article.

The second adhesive layer is formed on a surface of the first adhesive layer away from the second identification layer, so as to allow adhesion of the fake-proof adhesive tape to the sealed article. The reinforced portion is one that is locally formed at least between the substrate and the first adhesive layer, and is formed at least on a side edge of the fake-proof adhesive tape, so as to strengthen an adhesion between the first identification layer and the second identification layer. The adhesion between the second identification layer and the first adhesive layer is weaker than an adhesion between the first adhesive layer and the second adhesive layer, and is also weaker than an adhesion between the second adhesive layer and the sealed article, so that the first adhesive layer and the second adhesive layer adhering to the sealed article still remain on the sealed article after the substrate of the fake-proof adhesive tape is torn off.

Also, among layers of the fake-proof adhesive tape, an adhesion between the first identification layer and the second identification layer is weaker than an adhesion between the substrate and the first identification layer, and the adhesion between the first identification layer and the second identification layer is weaker than the adhesion between the second identification layer and the first identification layer. On the other hand, an adhesion between the substrate and the second identification layer is stronger than the adhesion between the first adhesive layer and the second identification layer, and an adhesion between the substrate and the reinforced portion is stronger than an adhesion between the reinforced portion and the second adhesive layer.

According to other embodiments, the adhesion between the substrate and the reinforced portion may be stronger or weaker than an adhesion between the reinforced portion and other film layers. Alternatively, the adhesion of the reinforced portion for the first adhesive layer and a side edge of the second adhesive layer are adapted to be stronger than the adhesion of the reinforced portion for other film layers, but the invention shall not be limited to the examples described above.

According to the fake-proof adhesive tape of the present invention, at least a side edge of the fake-proof adhesive tape may be formed with the reinforced portion the adhesion between the reinforced portion and the first adhesive layer is stronger than the adhesion between portions outside the reinforced portion and the first adhesive layer. As a result, conventional problems such as separation difficulty and peeling do not occur between the first and second identification layers. Thus, the fake-proof adhesive tape that ensures fake-proof sealing effect is provided. And since the reinforced portion is formed at least on the side edge of the fake-proof adhesive tape, the user can easily tear the fake-proof adhesive tape.

Thus, the article can be kept at the sealed state and well secured using the fake-proof adhesive tape. Also, various drawbacks caused by the adhesion not easily controlled between the mark layer and the colored layer in the prior art can be solved. And the adhesive tape can be easily torn to improve convenience in terms of utilization.

While in the following, the present invention will be described in detail according to specific embodiments, those skilled in the art can further understand other advantages and functions of the present invention according to described illustration. The present invention also can be implemented or applied by other specific embodiments, in the present descriptions, numerous specific details can be based upon various views and applications, the invention can be capable of modifications variations within sprit of the invention.

### BRIEF DESCRIPTION OF THE DRAWINGS

FIG. 1 is a cross-sectional view illustrating a fake-proof adhesive tape according to a first embodiment of the present invention;

FIG. 2 is a cross-sectional view illustrating the fake-proof adhesive tape adhering to a sealed article according to the first embodiment of the present invention;

FIG. 3 is an elevation view illustrating the fake-proof adhesive tape adhering to the sealed article the first embodiment of the present invention;

FIG. 4 is a schematic diagram illustrating a tearing state at which the fake-proof adhesive tape is torn according to the first embodiment of the present invention;

FIG. 5 is a schematic diagram illustrating a separation state after the fake-proof adhesive tape is torn according to the first embodiment of the present invention;

FIG. 6 is an elevation view illustrating a portion of the fake-proof adhesive tape remained on the sealed article after the adhesive tape is tore according to the first embodiment of the present invention;

FIG. 7 is an elevation view illustrating a substrate portion after the fake-proof adhesive tape is torn according to the first embodiment of the present invention;

FIG. 8 is a cross-sectional view illustrating a fake-proof adhesive tape according to a second embodiment of the present invention;

FIG. 9 is an elevation view illustrating the fake-proof adhesive tape remained on the sealed article after the adhesive tape is torn according to the second embodiment of the present invention;

FIG. 10 is an elevation view illustrating a substrate portion after the fake-proof adhesive tape is torn according to the second embodiment of the present invention;

FIG. 11 is a cross-sectional view illustrating a fake-proof adhesive tape according to a third embodiment of the present invention;

FIG. 12 is an elevation view illustrating a portion of the fake-proof adhesive tape remained on the sealed article after the adhesive tape is torn according to the third embodiment of the present invention;

FIG. 13 is an elevation view illustrating a substrate portion after the fake-proof adhesive tape is torn according to the third embodiment of the present invention;

FIG. 14 is a cross-sectional view illustrating a fake-proof adhesive tape according to a fourth embodiment of the present invention;

FIG. 15 is a cross-sectional view illustrating the fake-proof adhesive tape according to the fourth embodiment of the present invention; and

FIG. 16 is a schematic diagram illustrating a conventional fake-proof adhesive tape.

### DETAILED DESCRIPTION OF THE PRESENT EMBODIMENTS

The present invention will be further described in the following embodiments, but the scope of the present invention shall not to limited by the embodiments adapted forth below.

First Embodiment

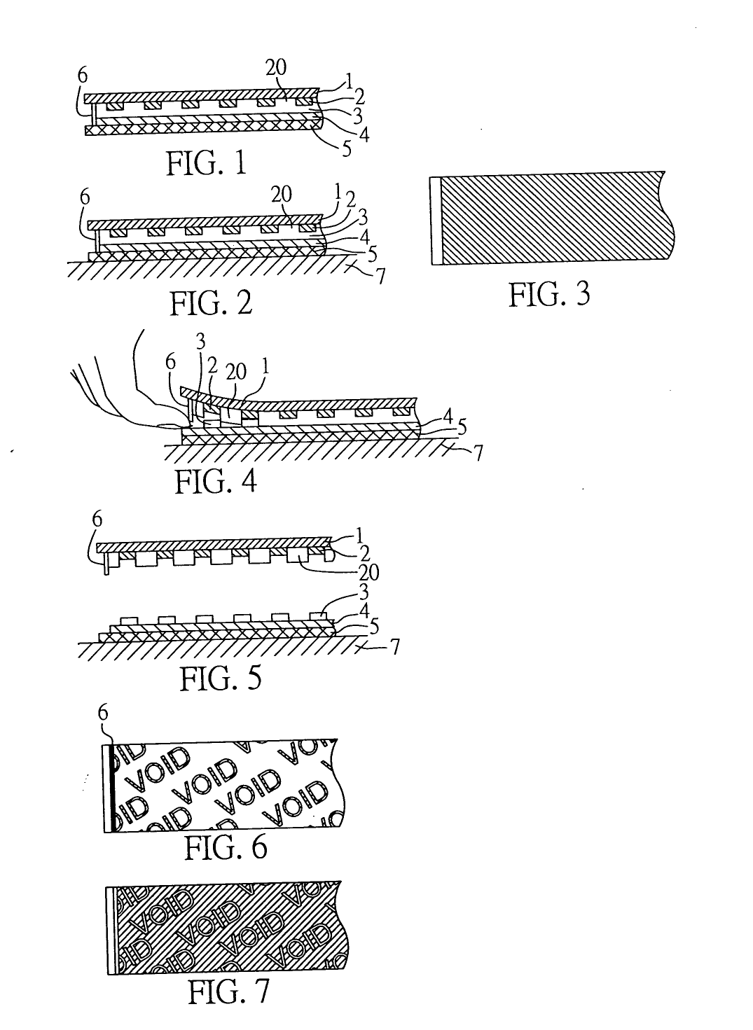

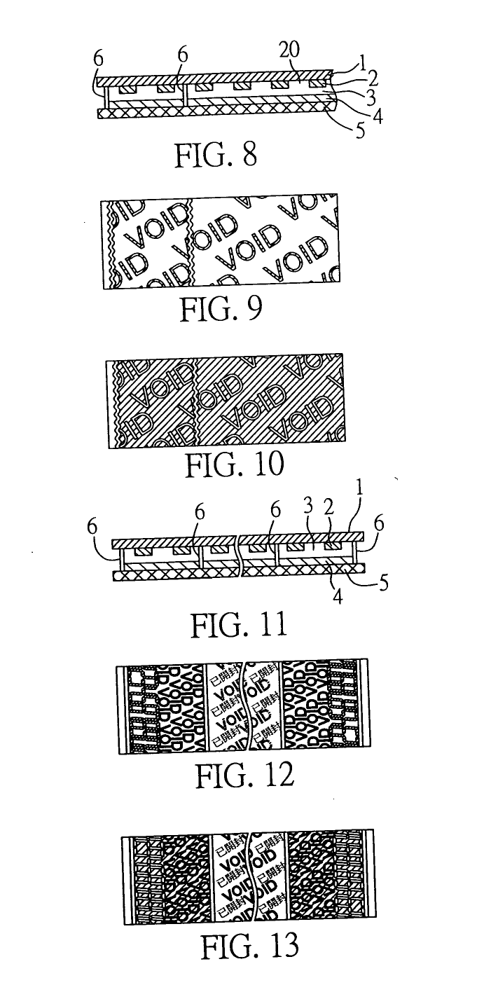

FIG. 1 through to FIG. 7 are diagrams illustrating a first embodiment of the present invention. A fake-proof adhesive tape comprises a substrate 1, a first identification layer 2, a second identification layer 3, a first adhesive layer 4, a second adhesive layer 5, and at least a reinforced portion 6. It should be noted that these diagrams are simplified schematic diagrams illustrating only basic structure of the invention. Therefore, only elements relevant to the invention are shown, and the elements in the diagrams are not drawn in actual shapes and scale. The actual identification marks, shapes, dimensions, and scales are a choice of design and configurations of the elements should be made more complex.

The substrate 1 may be a thin film made of plastic. Although the substrate 1 in this embodiment is made of transparent plastic material, the substrate 1 may also be made of colored or semi-transparent plastic material, and since structure and material characteristics of the substrate 1 are well-known and not the critical features of the present invention, they are not further described herein.

The first identification layer is locally formed on a surface of the substrate 1 and is optionally made of resin material having the same color and transparency as the substrate 1, such that an adhesion exists between the first identification layer 2 and the substrate 1. The first identification layer 2 is formed with a tearing mark by using any of printing techniques to show identification state in such a way that the mark is printed on a back surface of the substrate 1 to reveal a sealing state of the fake-proof adhesive tape. Since the first identification layer 2 can be formed of the tearing mark with any fonts, patterns, or marks, first identification layer 2 is not limited to those described in the present embodiment.

The second identification layer 3 is formed over the surface of the substrate 1 on which the first identification layer 2 is formed, so as to completely cover the first identification layer. The second identification layer 3 may be made of any material, such as ink having a color that contrasts with those of the substrate 1 and the first identification layer 2, so as to clearly identify that the sealing state has been damaged after the substrate 1 is torn. In the present embodiment, the second identification layer 3 is formed on the back surface of the first identification layer 2 away from the substrate 1 to fill a gap 20 that is formed in the first identification layer 2 to partially expose the back surface of the substrate 1. In other words, the substrate 1 is formed with the second identification layer 3 except a portion of the back surface with the tearing mark revealing an identification state of the first identification layer 2. As a result, the sealing state of the fake-proof adhesive tape is shown via connection between the first identification layer 2 and the second identification layer 3.

The first adhesive layer 4 is formed on a surface of the second identification layer 3 away from the first identification layer 2, and the first adhesive layer 4 may be made of bonding film, such that the second identification layer 3 coated on the first identification layer 2 remains on the first adhesive layer 4 is adhered to the sealed article 7 via the first adhesive layer 4 for maintaining the sealing end tightly sealed after the substrate 1 is torn from the first adhesive layer 4 of the tape . The first adhesive layer may be colored or colorless, but it is preferably for the identification layer 3 to have color that contrasts with that of the first adhesive layer 4, so that the sealing state is visually checked for any damage after the substrate 1 is torn from the sealed article 7.

The second adhesive layer 5 is formed on a surface of the first adhesive layer 4 away from the second identification layer 3, and the second adhesive layer 5 may be an adhesive layer coated on the first adhesive layer 4 so as to allow the fake-proof adhesive tape adhering to the sealed article. An adhesion between the second identification layer 3 and the first adhesive layer 4 is weaker than an adhesion between the first adhesive layer 4 and the second adhesive layer 5, and is weaker than an adhesion between the second adhesive layer 5 and the sealed article 7. As a result, the first adhesive layer 4 and the second adhesive layer 5 that adhere to the sealed article 7 still remain on the sealed article 7 to keep the sealing end of the sealed article tightly sealed after the substrate 1 of the tape is torn.

The reinforced portion 6 is a dam bar structure formed on a side edge of the fake-proof adhesive tape. As shown in the diagrams, the reinforced portion 6 is formed between the substrate 1 and the second adhesive layer 5. That is, the reinforced portion 6 is formed at a suitable location among the first identification layer 2, the second identification layer 3 and the first adhesive layer 4, and the reinforced portion 6 may be a linear reinforced portion with adhesive property. In the present embodiment, the adhesion between the reinforced portion 6 and the first adhesive layer 4 is adapted to be stronger than the adhesion between portion outside the reinforced portion 6 of the second identification layer 3 and the first adhesive layer 4. The reinforced portion 6 is formed on the side edge of the substrate 1 and the second adhesive layer 5. However, it is noted that the reinforced portion 6 may also be formed between the substrate 1 and the first adhesive layer 4 or at other locations, and not to be limited to the illustrations in the present embodiment.

Meanwhile, the reinforced portion 6 provides adhesion between the first identification layer 2 and the second identification layer 3. And as long as the reinforced portion 6 is at least formed at location on the second identification layer 3, and the reinforced portion 6 is formed at least on the side edge of the fake-proof adhesive tape and/or formed in any equivalent portion of the fake-proof adhesive tape, other reinforced portion may be applicable to the adhesive tape of the present invention.

The reinforced portion 6 is formed on the side edge of the fake-proof adhesive tape, specifically on the side edges of the first identification layer 2 and the identification layer 3, so the adhesion between the first identification layer 2 and the identification layer 3 is strengthened, and the first identification layer 2, the identification layer 3, and the first adhesive layer 4 are isolated from the outside. So, conventional problems related to separation difficulty and peeling between the first and second identification layers do not occur.

Further, among different layers of the fake-proof adhesive tape, an adhesion between the first identification layer 2 and the second identification layer 3 is weaker than an adhesion between the substrate 1 and the first identification layer 2, and the adhesion between the first identification layer 2 and the second identification layer 3 is weaker than an adhesion between the first adhesive layer 4 and the second identification layer 3. However, an adhesion between the substrate 1 and the first adhesive layer 4 is stronger than the adhesion between the first adhesive layer 4 and the second identification layer 3, and the adhesion between the substrate 1 and the reinforced portion 6 is stronger than the adhesion between the reinforced portion 6 and the second adhesive layer 5. Although the present embodiment is only described with the reinforced portion formed between the substrate 1 and the second adhesive layer 5, it should be noted that the reinforced portion 6 may also be formed between other layers or side edge of other layer according to other embodiments. And the adhesion between the substrate 1 and the reinforced portion 6 may be stronger or weaker than the adhesion of the reinforced portion 6 for other layers. Alternatively, the adhesion between the reinforced portion 6 and the side edge of the first adhesive layer 4 and the second adhesive layer 5 is adapted to be stronger than the adhesion of the reinforced portion 6 for other layers, but the present invention is not limited as such.

As shown in FIG. 2, the fake-proof adhesive tape of the present invention is handled in a similar manner as common adhesive tape, a piece of the fake-proof adhesive tape with a suitable length is cut out to adhere to the sealed article 7, thereby providing dual functions of fake-proof and security that are not achieved by the common adhesive tape.

As shown in FIG. 3, the reinforced portion 6 is formed on the side edge of the fake-proof adhesive tape when a view is taken from a top surface of the fake-proof adhesive tape, so as to strengthen the adhesion between the first identification layer 2 and the second identification layer 3 without peeling. Therefore, only a single color of the second identification 3 is shown on the surface of the fake-proof adhesive tape without revealing the tearing mark. In other words, the user can confirm that the sealing state of the fake-proof adhesive tape has not been damaged at this time.

Referring to FIG. 4 and FIG. 5, the user can tear the fake-proof adhesive tape from the edge of the substrate 1 and the second adhesive layer 5. Since the adhesions between the layers of the adhesive tape are different, of the adhesion between the first identification layer 2 and the second identification layer 3 is weaker than the adhesion between the substrate 1 and the first identification layer 2, and the adhesion between the substrate 1 and the reinforced portion 6 is stronger than the adhesion between the reinforced portion 6 and the second adhesive layer 5. However, the adhesion between the substrate 1 and the second identification layer 3 is stronger than the adhesion between the first adhesive layer 4 and the second identification layer 3, allowing the first identification layer 2, portions of the second identification layer 3, and the reinforced portion 6 to detach together with the substrate 1 from the fake-proof adhesive tape. Also, the adhesion between the first identification layer 2 and the second identification layer 3 is weaker than the adhesion between the first adhesive layer 4 and the second identification layer 3, while the adhesion of the first adhesive layer 4 and the second adhesive layer 5 for the sealed article 7 is stronger than the adhesion between the first adhesive layer 4 and the second identification layer 3. So, the first adhesive layer 4, the second adhesive layer 5 and a portion of the second identification layer 3 still adhere to the sealed article 7, as shown in FIG. 6 and FIG. 7.

As shown in FIG. 6, since the adhesion between the first identification layer 2 and the second identification layer 3 is weaker than the adhesion between the first adhesive layer 4 and the second identification layer 3, the second identification layer 3 that adheres to the sealed article 7 would be left with the second identification layer 3 initially covered on the first identification layer 2, after the substrate 1 of the fake-proof adhesive tape is torn. Thus, when the first adhesive layer 4 is viewed from the top, it is found that the tearing mark for revealing the sealing state is damaged, and tearing of the fake-proof adhesive tape is identified.

By comparing FIG. 6 and FIG. 7, it is known that the portions of the second identification layer 3 in the gap 20 of the first identification layer 2 that are torn together with the substrate 1 shows reversed phase pattern to those represented on the surface of the sealed article 7. Further, the sealing state of the fake-proof adhesive tape is damaged as the substrate 1 is torn, but the first adhesive layer 4 is still acted upon by the second adhesive layer 5 to remain adhering to the sealing end of the sealed article 7, and keeping the sealing end of the sealed article 7 tightly sealed via the first adhesive layer 4. Thus, the first adhesive layer 4 and the second adhesive layer 5 ensure the security of the sealed article 7 even though the fake-proof adhesive tape is torn, providing double protections for the user when the article is sealed.

Summarizing the above, it is understood that the side edge of the fake-proof adhesive tape is formed with the reinforced portion 6, so the adhesion between the first identification layer 2 and the second identification layer 3 is maintained by the reinforced portion 6 when the fake-proof adhesive tape is used. The fake-proof adhesive tape of the present invention control the adhesion between the first identification layer 2 and the second identification layer 3 easily via the reinforced portion 6 to not only ensure fake-proof sealing effect but also easy tearing, making the use of the adhesive tape more convenient.

Second Embodiment

FIG. 8 through to FIG. 10 are diagrams drawn according to a second embodiment of the present invention. The fake-proof adhesive tape comprises a substrate 1, a first identification layer 2, a second identification layer 3, a first adhesive layer 4, a second adhesive layer 5, and at least a reinforced portion 6. The fake-proof adhesive tape is described with an example of the adhesive tape applied to reveal sealing state of article with the same functions as the embodiment described above. Hence, those parts similar to the previous embodiments are illustrated with the same reference numerals and are not repetitively described, so that the inventive features and benefits can be more easily understood.

The present embodiment differs from the first embodiment is that the fake-proof adhesive tape of the present embodiment is formed with two wavelike reinforced portions 6. The reinforced portion 6 of the first embodiment is formed on any side edge of the fake-proof adhesive tape and has a linear structure, whereas the reinforced portions 6 of the present embodiment are formed respectively on the side edge of the fake-proof adhesive tape and close to central location of the fake-proof adhesive tape.

The reinforced portion 6 is formed between the substrate land the second adhesive layer 5, and the reinforced portion 6 is also located on the side edges of the first identification 2 and the second identification layer 3 to enhance control of the adhesion between the first identification 2 and the second identification layer 3.

Third Embodiment

FIG. 11 through to FIG. 13 are diagrams drawn according to the third embodiment of the present invention. The fake-proof adhesive tape comprises a substrate 1, a first identification layer 2, a second identification layer 3, a first adhesive layer 4, a second adhesive layer 5, and at,least a reinforced portion 6. Hence, the fake-proof adhesive tape of the present embodiment is described with functions that are different from the previous embodiments, and those parts similar to the previous embodiments are illustrated with the same reference numerals, so that the inventive features and benefits can be more easily understood.

The present embodiment differs from the first embodiment in that the fake-proof adhesive tape of the present embodiment is formed with four reinforced portions 6. The reinforced portions 6 are located on the sidewalls of the first identification layer 2 and the second identification layer 3, and are formed on both side edges of the fake-proof adhesive tape and close to both side edges outside of the fake-proof adhesive tape, so as to enhance control of the adhesion between the first identification layer 2 and the second identification layer 3.

Also, the reinforced portions can be modified for height, width, adhesion?quantity?adapted location and shape thereof, depending on the actual needs without being limited to the embodiments as described above. The reinforced portions 6 can be formed in a continuous or consecutive manner, and the adhesion between the substrate 1 and the reinforced portion 6 may also be weaker than the adhesion between the reinforced portion 6 and the second adhesive layer 5, as long as the adhesion between the first identification layer 2 and the second identification layer 3 is maintained by the reinforced portions 6

Fourth Embodiment

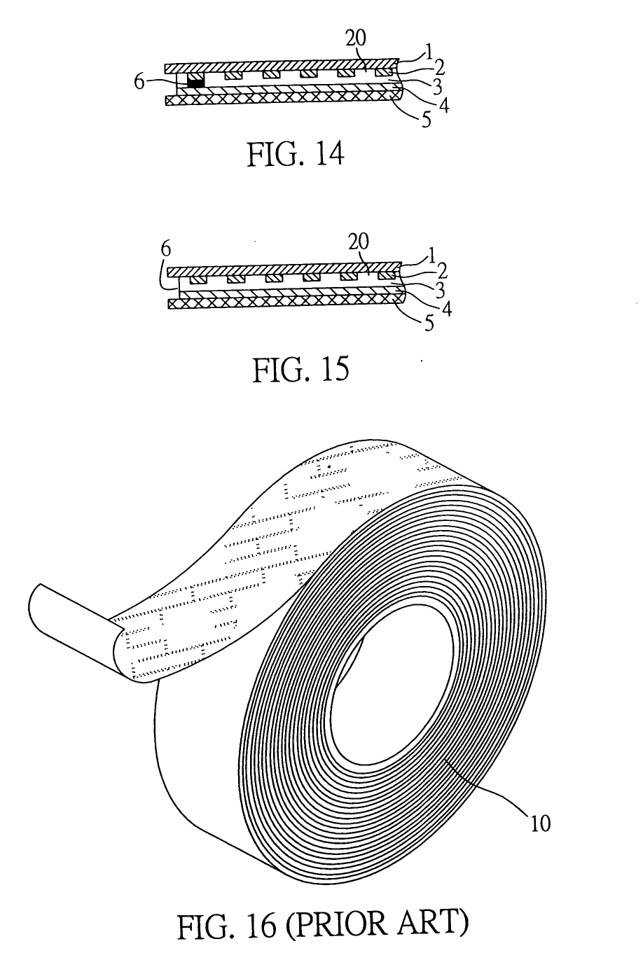

FIG. 14 is a diagram drawn according to a fourth embodiment of the present invention. As shown in FIG. 14, the fake-proof adhesive tape comprises a substrate 1, a first identification layer 2, a second identification layer 3, a first adhesive layer 4, a second adhesive layer 5, and at least a reinforced portion 6. Hence, the fake-proof adhesive tape of the present embodiment is described with functions that are different from the previous embodiments, and those parts similar to the previous embodiments are illustrated with the same reference numerals.

The present embodiment differs from the first embodiment in that the reinforced portion 6 in the fake-proof adhesive tape is locally formed on the second identification layer 3, and the reinforced portions 6 is formed on a junction between the first identification layer 2 and the second identification layer 3 to strengthen the adhesion between the first identification layer 2 and the second identification layer 3. The reinforced portion 6 is a film layer according to the present embodiment. But the reinforced portion 6 may also be a reinforced portion formed by the first identification layer 2 and the second identification layer 3 which are subjected to local adhesion reinforcement processing in other embodiments. In other words, the reinforced portion 6 can be a single film layer or a reinforced structure between the first identification layer 2 and the second identification layer 3 which are subjected to reinforcement processing. Since the adhesion reinforcement processing is a well-known technology, the details thereof are omitted herein.

Fifth Embodiment

FIG. 15 is a diagram drawn according to the fifth embodiment of the present invention. As shown in FIG. 15, the fake-proof adhesive tape comprises a substrate 1, a first identification layer 2, a second identification layer 3, a first adhesive layer 4, a second adhesive layer 5, and at least a reinforced portion 6. Hence, the fake-proof adhesive tape of the present embodiment is described with functions that are different from the previous embodiments, and those parts similar to the previous embodiments are illustrated with the same reference numerals.

The present embodiment differs from the first embodiment in that the reinforced portion 6 is locally formed between the substrate 1 and the first adhesive 4, and the reinforced portion is free of the first identification layer 2 and the second identification layer 3, so that the adhesion between the first identification layer 2 and the second identification layer 3 is strengthened using the substrate 1 and the first adhesive layer 4.

The reinforced portion 6 is formed on a side edge of the fake-proof adhesive tape in the present embodiment, but the reinforced portion may also be formed on both side edges of the fake-proof adhesive tape or outside the both side edges of fake-proof adhesive tape in other embodiments. The reinforced portion 6 can certainly be a reinforced structure formed between the first identification layer 2 and the second identification layer 3 which are subjected to reinforcement processing, or the reinforced portion 6 may be formed between the first identification layer 2 and the second identification layer 3 without being limited to those described in the present embodiment.

Therefore, it is understood that the fake-proof and tight sealing effect are ensured by the fake-proof tape having the reinforced portion when the user fixes the fake-proof adhesive tape to the sealed article. And the fake-proof adhesive tape can be torn from the side edge of the fake-proof adhesive tape having the reinforced portion to facilitate its utilization. After the fake-proof adhesive tape of the present invention is fixed on the sealed article, peeling does not occur between the identification layers, so the user can use safely without suspecting if the fake-proof adhesive tape has been torn before.

According to the fake-proof adhesive tape of the present invention, various problems associated with conventional techniques which could not provide the fake-proof adhesive tape with fake-proof security property are resolved. Also, the fake-proof adhesive tape provides tight seal and fake-proof identification functions, and facilitates the utilization of the fake-proof adhesive tape.

While the illustrative embodiments are provided in the above description, such is for illustration of principles and functions of the present invention only and it is not to be construed restrictively. Modifications and variations of the present invention that will be obvious to those skilled in the art are to be covered by the following claims.

1. A fake-proof adhesive tape, comprising:
a substrate;
a first identification layer locally formed on a surface of the substrate;
a second identification layer formed over the surface of the substrate for completely covering the first identification layer;
a first adhesive layer formed on a surface of the second identification layer away from the first identification layer; and
a second adhesive layer formed on a surface of the first adhesive layer away from the second identification layer;
wherein an adhesion between the second identification layer and the first adhesive layer is weaker than an adhesion between the first adhesive layer and the second adhesive layer, the adhesion between the second identification layer and the first adhesive layer is weaker than an adhesion between the second adhesive layer and a sealed article, and the fake-proof adhesive tape is characterized by having at least a reinforced portion locally formed between the substrate and the first adhesive layer, for strengthening an adhesion between the first identification layer and the second identification layer, so as to prevent peeling between the first identification layer and the second identification layer.

2. The fake-proof adhesive tape of claim 1, wherein the reinforced portion is free of the first identification layer and the second identification layer.

3. The fake-proof adhesive tape of claim 1, wherein the reinforced portion is formed between the first identification layer and the second identification layer.

4. The fake-proof adhesive tape of claim 1, wherein the substrate is a thin film.

5. The fake-proof adhesive tape of claim 1, wherein the first identification layer is formed with a tearing mark for revealing an identification state.

6. The fake-proof adhesive tape of claim 1, wherein the adhesion between the first identification layer and the second identification layer is weaker than an adhesion between the substrate and the first identification layer.

7. The fake-proof adhesive tape of claim 1, wherein an adhesion between the substrate and the second identification layer is stronger than the adhesion between the second identification layer and the first adhesive layer.

8. The fake-proof adhesive tape of claim 1, wherein the adhesion between the first identification layer and the second identification layer is weaker than the adhesion between the second identification layer and the first adhesive layer.

9. The fake-proof adhesive tape of claim 1, wherein the first adhesive layer is an adhesive film.

10. The fake-proof adhesive tape of claim 1, wherein the second adhesive layer is a glue adhesive layer adhering to the sealed article.

11. The fake-proof adhesive tape of claim 1, wherein the reinforced portion is formed on at least a side edge of the fake-proof adhesive tape.

12. A fake-proof adhesive tape, comprising:
a substrate;
a first identification layer locally formed on a surface of the substrate;
a second identification layer formed over the surface of the substrate for completely covering the first identification layer;
a first adhesive layer formed on a surface of the second identification layer away from the first identification layer; and
a second adhesive layer formed on a surface of the first adhesive layer away from the second identification layer;
wherein an adhesion between the second identification layer and the first adhesive layer is weaker than an adhesion between the first adhesive layer and the second adhesive layer, the adhesion between the second identification layer and the first adhesive layer is weaker than an adhesion between the second adhesive layer and a sealed article, and the fake-proof adhesive tape is characterized by having at least a reinforced portion formed on the second identification layer, such that an adhesion between the first adhesive layer and the reinforced portion is stronger than an adhesion between the first adhesive layer and portions of the second identification layer outside the reinforced portion, so as to prevent peeling between the first identification layer and the second identification layer.

13. The fake-proof adhesive tape of claim 12, wherein the substrate is a thin film.

14. The fake-proof adhesive tape of claim 12, wherein the first identification layer is formed with a tearing mark for revealing an identification state.

15. The fake-proof adhesive tape of claim 12, wherein the adhesion between the first identification layer and the second identification layer is weaker than an adhesion between the substrate and the first identification layer.

16. The fake-proof adhesive tape of claim 12, wherein an adhesion between the substrate and the second identification layer is stronger than the adhesion between the second identification layer and the first adhesive layer.

17. The fake-proof adhesive tape of claim 12, wherein the adhesion between the first identification layer and the second identification layer is weaker than the adhesion between the second identification layer and the first adhesive layer.

18. The fake-proof adhesive tape of claim 12, wherein the first adhesive layer is an adhesive film.

19. The fake-proof adhesive tape of claim 12, wherein the second adhesive layer is a glue adhesive layer adhering to the sealed article.

20. The fake-proof adhesive tape of claim 12, wherein the reinforced portion is formed on at least a side edge of the fake-proof adhesive tape.
